(19) United States
(12) Patent Application Publication
(10) Pub. No.: US 2003/0018761 A1
(43) Pub. Date: Jan. 23, 2003

(54) Enhanced configuration of infiniband links

(76) Inventors: Patrick Doyle, Hillsboro, OR (US); Nelson Ge, Temeucula, CA (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 09/752,369

(22) Filed: Dec. 29, 2000

(51) Int. Cl. G06F 15/173; G06F 3/00

(52) U.S. Cl. 709/223; 710/15

(57) ABSTRACT

According to the invention, an apparatus and method are disclosed for requesting and providing enhanced InfiniBand connectivity configurations.

### FIELD OF THE INVENTION

This invention relates to computer networks in general, and more specifically to the configuration of InfiniBand links.

### BACKGROUND OF THE INVENTION

In order to overcome many of the problems and limitations that are inherent in common system bus technologies, new architectures are being developed. The InfiniBand architecture is a new standard based on switched serial links to device groups and devices. In the InfiniBand architecture, all devices are attached through a central, unified fabric of InfiniBand switches and links. InfiniBand architecture is intended to simplify and accelerate server-to-server connections and links to other server-related systems, such as remote storage and networking devices. InfiniBand is a merged proposal that was derived from the Next Generation I/O group (NGIO) and the Future I/O group (FIO).

The standards for the InfiniBand architecture are being developed by the InfiniBand Trade Association (ITA), and are provided in the architecture specification for the system. (InfiniBand Architecture Specification, Release 1.0, Oct. 24, 2000) (hereinafter referred to as the “Specification”) In addition to other features of InfiniBand architecture that are described in the Specification, there are specifications for connectivity configurations. Only certain limited configurations are provided in the Specification, these configurations being 1X, 4X, and 12X links.

For InfiniBand configurations, connections are defined by “physical lanes”. A physical lane is comprised of one transmit differential pair of conductors and one receive differential pair of conductors. A 1X, 4X or 12X link is composed of one, four, or twelve physical lanes, respectively. The twelve possible physical lanes on a standard InfiniBand backplane connector are designated by lane identifiers 0 through 11. Under the Specification, a 1X link must use physical lane 0, a 4X link must use physical lanes 0 through 3, and a 12X link must use physical lanes 0 through 11, as shown in Table 1. No other possible configurations are specified, and only a single link is specified for any connector in use.

TABLE 1

| Lane | Hex | |
|---|---|---|
| Identifier | Number | Description |
| 0 | 00 | Used by 1X, 4X, and 12X links |
| 1 | 01 | Used by 4X and 12X links |
| 2 | 02 | Used by 4X and 12X links |
| 3 | 04 | Used by 4X and 12X links |
| 4 | 08 | Used by 12X link |
| 5 | 0F | Used by 12X link |
| 6 | 10 | Used by 12X link |
| 7 | 17 | Used by 12X link |
| 8 | 18 | Used by 12X link |
| 9 | 1B | Used by 12X link |
| 10 | 1D | Used by 12X link |
| 11 | 1E | Used by 12X link |

The Specification thus defines the possible connectivity configurations using an InfiniBand connector as including only a single 1X link, a single 4X link, or a single 12X link with rigid pin-outs. If a 1X link is present, eleven of the twelve physical lanes on a standard connector remain unused. If a 4X link is present, eight of the twelve physical lanes on a standard connector are unused.

As shown in FIG. 1, a typical InfiniBand backplane connector 100 contains a plurality of connections 110, these connections being the twelve physical lanes numbered 0 through 11 in this example. An InfiniBand backplane connector also includes a management link, bulk power connections, and auxiliary power connections, which are not shown in this illustration. Typically, connector 100 utilizes either the first connection in configuration 120 for a 1X link, the first four connections in configuration 130 for a 4X link, or all twelve connections in configuration 140 for a 12X link. No other connectivity configuration for the connector is provided in the Specification. The usage of a standard connector is therefore very limited, and does not allow for flexibility in configuration, or allow for the provision of multiple links on a single connector. For this reason, the limitations in the Specification standards do not allow sufficient options to precisely balance the data flow into and out of an InfiniBand module and do not allow full use of the capabilities of the InfiniBand architecture.

### BRIEF DESCRIPTION OF THE DRAWINGS

The appended claims set forth the features of the invention with particularity. The invention, together with its advantages, may be best understood from the following detailed descriptions taken in conjunction with the accompanying drawings, of which:

FIG. 1 is an illustration of the InfiniBand link portion of an InfiniBand standard backplane connector and the typical alternative connectivity configurations provided for said connector;

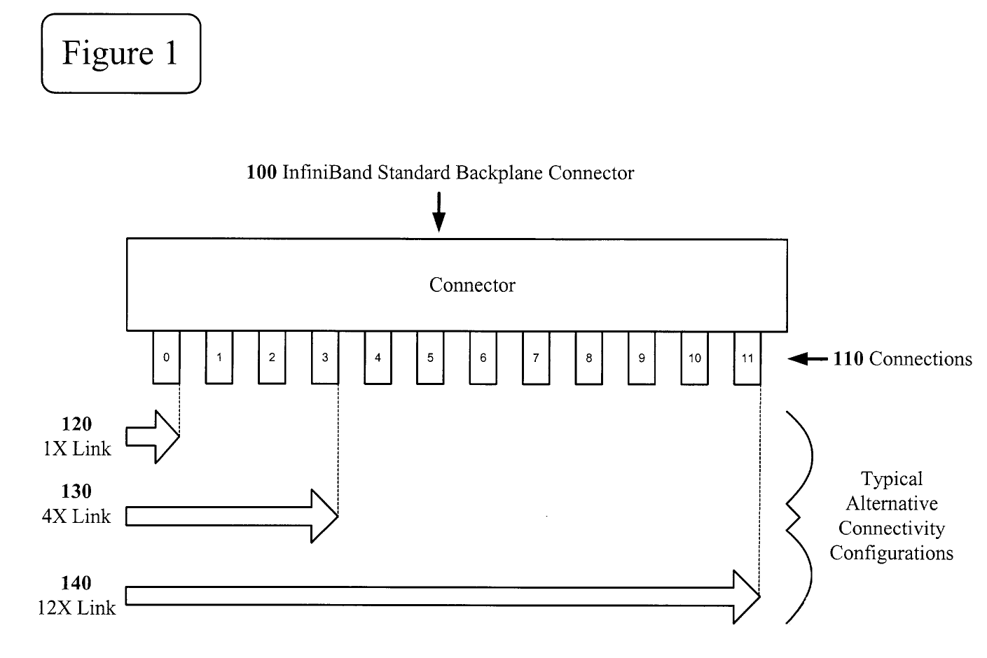

FIG. 2 is an illustration of certain examples of expanded connectivity configurations possible using the InfiniBand link portion of an InfiniBand standard backplane connector according to one embodiment;

FIG. 3 illustrates the typical backplane connections for an InfiniBand chassis and an InfiniBand module;

FIG. 4 illustrates the backplane connections for an InfiniBand chassis and an InfiniBand module and the process of requesting a connectivity configuration and responding to such request according to one embodiment;

FIG. 5 is a flow diagram illustrating the operation of an InfiniBand module according to an embodiment; and

FIG. 6 is a flow diagram illustrating the operation of an InfiniBand chassis according to an embodiment.

### DETAILED DESCRIPTION

A method and apparatus are described for configuring expanded InfiniBand links.

In the following description, for the purposes of explanation, numerous specific details are set forth in order to provide a thorough understanding of the present invention. It will be apparent to one skilled in the art that the present invention may be practiced without some of these specific details. In other instances, well-known structures and devices are shown in block diagram form.

The present invention includes various steps, which will be described below. The steps of the present invention may be performed by hardware components or may be embodied in machine-executable instructions, which may be used to cause a general-purpose or special-purpose processor or logic circuits programmed with the instructions to perform the steps. Alternatively, the steps may be performed by a combination of hardware and software.

Under one embodiment, the possible connectivity configurations for the InfiniBand architecture are expanded beyond the configurations provided in the Specification. Different links are possible under this embodiment, and multiple links may be provided simultaneously using the physical lanes defined by the Specification. Under this embodiment, the requirements of the Specification continue to be met, and the limited connectivity configurations that are provided in the Specification remain available.

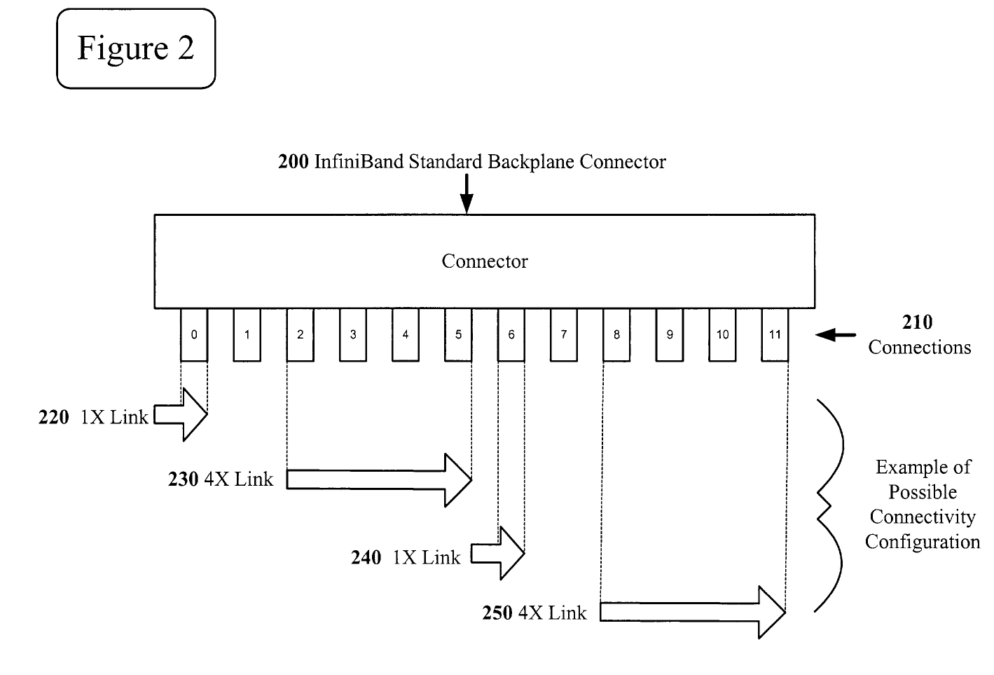

One embodiment utilizes a standard InfiniBand backplane connector to allow connectivity configurations beyond those provided in the InfiniBand Specification. An embodiment allows a combination of different links to be provided simultaneously on a single connector. As shown in FIG. 2, InfiniBand backplane connector 200 contains a plurality of connections 210, which are physical lanes 0 through 11 in this illustration. An InfiniBand backplane connector also includes a management link, bulk power connections, and auxiliary power connections, which are not shown in FIG. 2. Under one embodiment, connector 200 could simultaneously provide for a 1X link through utilization of configuration 220, a 4X link through utilization of configuration 230, a 1X link through utilization of configuration 240, and a 4X link through utilization of configuration 250. Under various embodiments, up to twelve 1X links or up to three 4X links could be established on a standard InfiniBand backplane connector that contains twelve physical lanes. The configurations described here and illustrated in FIG. 2 are meant solely as an example of the usage of a single connector under one embodiment, and such configurations do not limit how the invention may be implemented. Many different links and combinations of links are possible using the invention.

According to one embodiment, an expanded connectivity configuration may be obtained by making a request for the configuration. A response to the configuration request is made, and the requested connection may be attempted if the response to the request is affirmative. Under one embodiment, the configuration request and the response to said request are made by InfiniBand devices that are defined by the Specification.

Under the Specification, an InfiniBand module is a unit that, at minimum, consists of an InfiniBand board, a carrier module, and a protective cover. The Specification provides that a module will include at least one InfiniBand link, a baseboard management agent, one InfiniBand management link agent (an interface to the InfiniBand management link), one module management entity, and the applications the module performs. Pursuant to one embodiment, such a module may request an expanded connectivity configuration. Under this embodiment, the request would be made to an InfiniBand chassis management entity, which is part of an InfiniBand chassis. Under the Specification, an InfiniBand management link (abbreviated as “IB-ML”) is defined, and such management link will connect devices on an InfiniBand module with an InfiniBand chassis. The management link allows communication between the chassis and the module entities, and is available even when the InfiniBand fabric is not operational and before a link is connected. Under this embodiment, the InfiniBand management link is used in a novel way not discussed in the Specification to provide a mechanism for making the connectivity request and the resulting response. Under one embodiment, a module requests an expanded connectivity configuration by making the request to the chassis management entity through the management link, and the chassis management entity responds through the management link regarding whether the chassis can support the requested connectivity configuration. The invention is not limited to a physical InfiniBand management link, but may also include communication using a virtual InfiniBand management link or other connection.

Under one embodiment, the configuration request by a module and the response by a chassis management entity may be made by writing to a memory space. According to one embodiment, the request is written to a configuration register in the vendor/product specific space in the management link's serial electrically erasable read only memory (SEEPROM). When a configuration request is made, the response by the chassis management entity to said request is written to another configuration register in the management link's SEEPROM. If the module detects a positive response to the module's request, the module then attempts to establish a connection over the requested links.

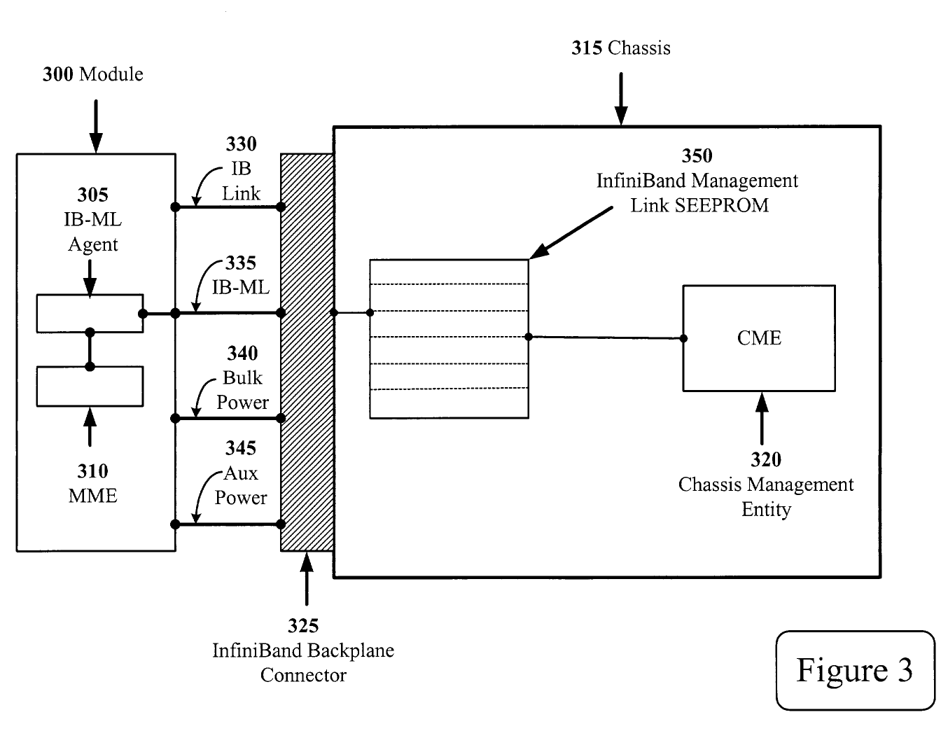

FIG. 3 is an illustration of a typical InfiniBand backplane connection. As shown in FIG. 3, a module 300 contains a management link agent 305 and a module management entity 310. Module 300 is connected to chassis 315, which contains chassis management entity 320. Module 300 and chassis 315 are connected by InfiniBand backplane connector 325. The connection is comprised of InfiniBand link 330, InfiniBand management link 335, and the power connections, which are comprised of bulk power connection 340 and auxiliary power connection 345. Chassis 315 includes InfiniBand management link SEEPROM 350. In this configuration, InfiniBand link 330 is limited to a single 1X, 4X, or 12X link that utilizes the physical lanes specified in Table 1.

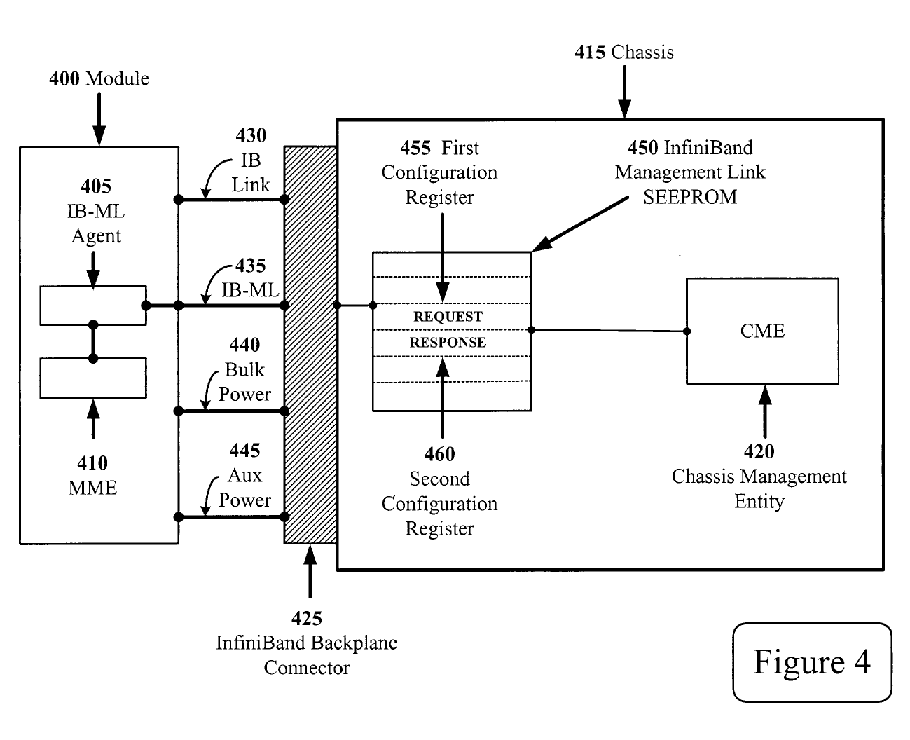

As shown in FIG. 4, an embodiment may comprise a module 400 containing management link agent 405 and module management entity 410. Module 400 is connected to chassis 415, which includes chassis management agent 420. Module 400 and chassis 415 are connected via InfiniBand backplane connector 425. The connection is comprised of InfiniBand link 430, InfiniBand management link 435, and the power connections, bulk power connection 440 and auxiliary power connection 445. Chassis 415 includes InfiniBand management link SEEPROM 450. According to this embodiment, module 400 is operable to request an expanded connectivity configuration from chassis 415. The module communicates the configuration request to chassis management entity 420 of chassis 415. The request is communicated using InfiniBand management link 435. According to this embodiment, module 400 writes the configuration request to a first configuration register 455 in the SEEPROM 445 for InfiniBand management link 430. Chassis management entity 420 detects the configuration request that has been written to the first configuration register 455. Upon detecting a configuration request, chassis management entity 420 issues a response to the module by writing the response to a second configuration register 460 in SEEPROM 450. The response that is written to second configuration register 460 indicates whether the chassis management entity can support the requested connectivity configuration. If module 400 detects a positive response to the configuration request, module 400 then attempts to establish the requested links.

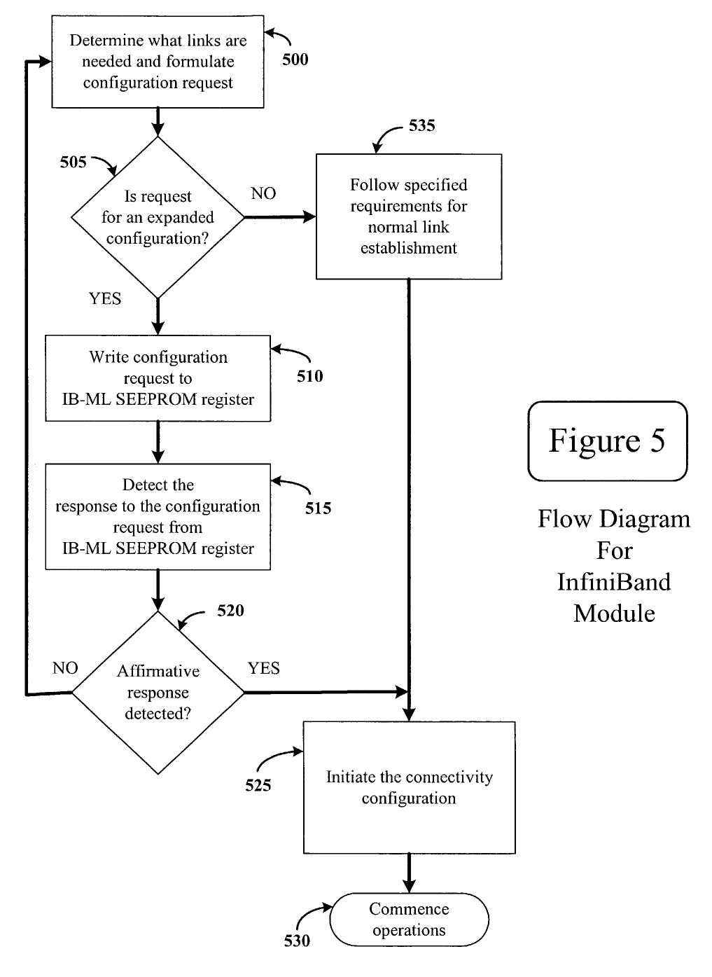

FIG. 5 contains a flow chart that illustrates the operation of an InfiniBand module according to one embodiment. In process block 500, the module determines what connectivity configuration is needed. If the request is for a configuration that is expanded beyond those provided in the Specification, process block 505, the module requests this configuration by writing the configuration request to a register in the InfiniBand management link SEEPROM, process block 510. The module detects the response regarding the configuration request, process block 515. If the response is in the affirmative, process block 520, the module will initiate the links contained in the requested configuration, process block 525, and commence operations, process block 530. According to this embodiment, if the response to the configuration request is not in the affirmative, process block 520, because the configuration request is denied or because the chassis does not respond to the request, the module will again formulate a configuration request, process block 500, and proceed through the process defined. If a request is not for an expanded configuration, process block 505, then the process may proceed according to the Specification. In this case, the module will follow the specified requirements for normal link establishment, process block 535, and proceed to initiate the configuration, 525, and commence operations, process block 530.

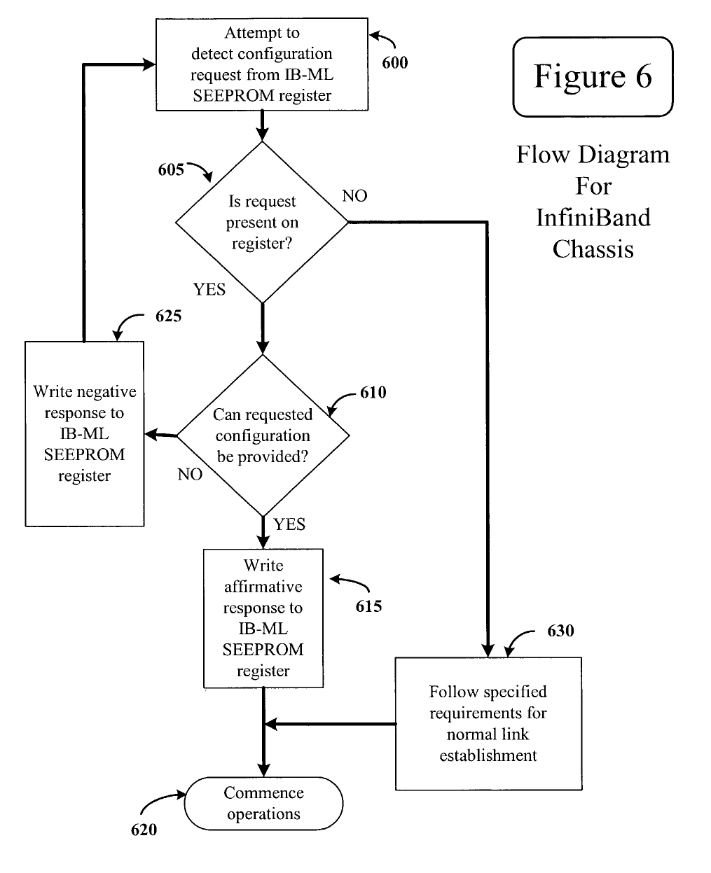

FIG. 6 contains a flow chart that illustrates the operation of an InfiniBand chassis according to one embodiment. From this point of view, the chassis attempts to detect any configuration request that has been written to a register in the management link SEEPROM. If there is a request present on a register, process block 605, the chassis will determine whether the configuration request can be provided, process block 610. If the request can be provided, the chassis writes an affirmative response to the request to a register in the management link SEEPROM, process block 615, and proceeds to commences operations, process block 620. If the configuration request cannot be provided, process block 610, the chassis will write a negative response to a register in the management link SEEPROM, process block 625, and again attempt to detect a configuration request on a register in the management link SEEPROM, process block 600. If no configuration request is present on a register in the management link SEEPROM, process block 605, then the chassis will follow the requirements contained in the Specification for normal link establishment, process block 630, and proceed to commence operations, process block 620.

What is claimed is:

1. A method comprising:
requesting an InfiniBand connectivity configuration;
receiving a response regarding whether the requested configuration can be provided; and
attempting to establish the requested connectivity configuration if the response to the request is affirmative.

2. The method of claim 1, wherein the requested connectivity configuration is not contained in the specification established for the InfiniBand architecture.

3. The method of claim 1, wherein the requested connectivity configuration is comprised of a plurality of links.

4. The method of claim 1, wherein the requested connectivity configuration is provided using a standard InfiniBand backplane connector.

5. The method of claim 1, wherein said request for a connectivity configuration is made by an InfiniBand module to an InfiniBand chassis management entity.

6. The method of claim 1, wherein said request for a connectivity configuration is made through an InfiniBand management link.

7. The method of claim 6, wherein said request for a connectivity configuration is written to a first management link configuration register and said response to said request is written to a second management link configuration register.

8. A method comprising:
receiving a connectivity configuration request associated with an InfiniBand connector, the configuration request representing an expanded InfiniBand connector configuration including information indicative of one or more desired links to be established through the InfiniBand connector and assigning one or more physical lanes of the InfiniBand connector to each of the one or more desired links; and
configuring the InfiniBand connector in accordance with said connectivity configuration request.

9. The method of claim 8, wherein said connectivity configuration request is made by an InfiniBand module and is received by an InfiniBand chassis management entity.

10. The method of claim 8, wherein said expanded InfiniBand connector configuration is not contained in the specification established for the InfiniBand architecture.

11. The method of claim 8, wherein said expanded InfiniBand connector configuration is comprised of a plurality of links.

12. A method comprising:
an InfiniBand management link operating to enable the establishment of an InfiniBand connectivity configuration, wherein said management link:
records a request for a connectivity configuration made by an InfiniBand module;
allows an InfiniBand chassis to obtain said request for a connectivity configuration;
records a response from said InfiniBand chassis to said request for a connectivity configuration; and
allows said InfiniBand module to obtain said response to said request for a connectivity configuration.

13. The method of claim 12, wherein said request for a connectivity configuration requests an expanded configuration that is not contained in the specification established for the InfiniBand architecture.

14. The method of claim 12, wherein said request for a connectivity configuration is written to a first management link configuration register and said response is written to a second management link configuration register.

15. The method of claim 12, wherein the requested connectivity configuration is comprised of a plurality of links.

16. A network apparatus comprising:
an InfiniBand connector;
an InfiniBand module that is operable to make a request for an expanded connectivity configuration for the InfiniBand connector;
a chassis management entity coupled to said InfiniBand module that receives the request for an expanded connectivity configuration for the InfiniBand connector and that provides a response regarding whether the requested configuration can be provided.

17. The network apparatus of claim 16, wherein said requested connectivity configuration is not contained in the specification established for the InfiniBand architecture.

18. The network apparatus of claim 16, wherein the requested connectivity configuration is other than:
a single link comprised of a connection to the first pin of a plurality of pins on the InfiniBand connector;
a single link comprised of a connection to the first four pins of the plurality of pins on the InfiniBand connector; or
a single link comprised of a connection to the first twelve pins of the plurality of pins on the InfiniBand connector.

19. The network apparatus of claim 16, wherein said InfiniBand module is operable to establish the requested connectivity configuration if the response to said connectivity request is affirmative.

20. The network apparatus of claim 16, wherein said requested connectivity configuration is comprised of a plurality of links that are provided simultaneously through said InfiniBand connector.

21. The network apparatus of claim 16, wherein the InfiniBand connector is a standard InfiniBand backplane connector.

22. The network apparatus of claim 16, wherein the said request for a connectivity configuration is made through an InfiniBand management link.

23. The network apparatus of claim 21, wherein said request for a connectivity configuration is written to a first management link configuration register and said response to said request is written to a second management link configuration register.

24. A machine readable medium having stored thereon data representing sequences of instructions which, when executed by a processor, cause the processor to perform operations comprising:
requesting an expanded InfiniBand connectivity configuration;
receiving a response regarding whether the requested configuration can be provided; and
establishing the requested configuration.

25. The medium of claim 24 wherein the requested connectivity configuration is not contained in the specification established for the InfiniBand architecture.

26. The medium of claim 24 wherein the requested connectivity configuration is comprised of a plurality of links.
